(19) United States
(12) Patent Application Publication
(10) Pub. No.: US 2022/0171603 A1
(43) Pub. Date: Jun. 2, 2022

(54) MULTIPLY-ACCUMULATE CALCULATION DEVICE, LOGICAL CALCULATION DEVICE, NEUROMORPHIC DEVICE, AND MULTIPLY-ACCUMULATE CALCULATION METHOD

(71) Applicant: TDK CORPORATION, Tokyo (JP)

(72) Inventor: Kazuki NAKADA, Tokyo (JP)

(73) Assignee: TDK CORPORATION, Tokyo (JP)

(21) Appl. No.: 17/439,992

(22) PCT Filed: Mar. 19, 2019
(86) PCT No.: PCT/JP2019/011504

§ 371 Date: Sep. 16, 2021

(51) Int. Cl. G06F 7/544

(52) U.S. Cl. CPC G06F 7/5443

(57) ABSTRACT

A multiply-accumulate calculation device includes a plurality of redundancy circuits including a plurality of multiply calculation elements and configured to input a plurality of first intermediate signals generated from an input signal corresponding to an input value to the plurality of multiply calculation elements and generate and output a plurality of second intermediate signals, each of which corresponds to a signal obtained by multiplying each of the plurality of first intermediate signals by a weight in each of the plurality of multiply calculation elements, a plurality of output signal generation circuits configured to generate output signals on the basis of the plurality of second intermediate signals and output the output signals, and an accumulate calculation circuit configured to calculate a sum of the output signals output by the plurality of output signal generation circuits.

### TECHNICAL FIELD

The present invention relates to a multiply-accumulate calculation device, a logical calculation device, a neuromorphic device, and a multiply-accumulate calculation method.

### BACKGROUND ART

At present, the development of a multiply-accumulate calculation device equipped with a multiply calculation element is being actively promoted. For example, in Patent Literature 1, a multiply-accumulate calculation device equipped with a multiply calculation device characterized in that an output value corresponding to a result of a multiply calculation on a multiplicand and a multiplier is output by inputting a first input signal corresponding to the multiplicand to one terminal of two terminals of a variable resistive element and inputting a second input signal corresponding to the multiplier to be multiplied by the multiplicand to the other terminal is disclosed.

### CITATION LIST

### Patent Literature

### Patent Literature 1

Japanese Patent No. 5160304

### SUMMARY OF INVENTION

### Technical Problem

However, the above-described multiply-accumulate calculation device may not be able to execute an accurate multiply-accumulate calculation because a signal different from a signal at the normal time may be output from the resistance change type variable resistance element when a failure occurs in the variable resistive element.

Therefore, an objective of the present invention is to provide a multiply-accumulate calculation device, a logical calculation device, a neuromorphic device, and a multiply-accumulate calculation method capable of performing an accurate multiply-accumulate calculation even when a failure occurs in a multiply calculation element.

### Solution to Problem

According to an aspect of the present invention, there is provided a multiply-accumulate calculation device including: a plurality of redundancy circuits including a plurality of multiply calculation elements and configured to input a plurality of first intermediate signals generated from an input signal corresponding to an input value to the plurality of multiply calculation elements and generate and output a plurality of second intermediate signals, each of which corresponds to a signal obtained by multiplying each of the plurality of first intermediate signals by a weight in each of the plurality of multiply calculation elements; a plurality of output signal generation circuits configured to generate output signals on the basis of the plurality of second intermediate signals and output the output signals; and an accumulate calculation circuit configured to calculate a sum of the output signals output by the plurality of output signal generation circuits.

Also, in an aspect of the present invention, each of the plurality of multiply calculation elements is a resistive change element having a write terminal, a common terminal, and a read terminal.

Also, in an aspect of the present invention, each of the plurality of first intermediate signals is generated using a source follower.

Also, in an aspect of the present invention, each of the plurality of first intermediate signals is generated using one of a plurality of resistors connected in series to each of the plurality of multiply calculation elements.

Also, in an aspect of the present invention, each of the plurality of first intermediate signals is generated using internal resistance of one of a plurality of current mirrors connected in series to each of the plurality of multiply calculation elements.

Also, in an aspect of the present invention, the output signal generation circuit is a minimum value selection circuit in which a signal corresponding to a minimum value among the plurality of second intermediate signals is used as the output signal.

Also, in an aspect of the present invention, the output signal generation circuit is a majority circuit in which a signal corresponding to a most frequent value among the plurality of second intermediate signals is used as the output signal.

Also, according to an aspect of the present invention, there is provided a logical calculation device including: the multiply-accumulate calculation device described above.

Also, according to an aspect of the present invention, there is provided a neuromorphic device including: the multiply-accumulate calculation device described above.

According to an aspect of the present invention, there is provided a multiply-accumulate calculation method including: a second intermediate signal generation step of inputting a plurality of first intermediate signals generated from an input signal corresponding to an input value to a plurality of multiply calculation elements and generating and outputting a plurality of second intermediate signals, each of which corresponds to a signal obtained by multiplying each of the plurality of first intermediate signals by a weight in each of the plurality of multiply calculation elements; a plurality of output signal generation steps of generating output signals on the basis of the plurality of second intermediate signals and outputting the output signals; and an accumulate calculation step of calculating a sum of the output signals output by the plurality of output signal generation circuits.

### Advantageous Effects of Invention

According to the multiply-accumulate calculation device, the logical calculation device, the neuromorphic device, and the multiply-accumulate calculation method described above, it is possible to provide a multiply-accumulate calculation device, a logical calculation device, a neuromorphic device, and a multiply-accumulate calculation method capable of performing an accurate multiply-accumulate calculation even when a failure occurs in a multiply calculation element.

### BRIEF DESCRIPTION OF DRAWINGS

FIG. 1 is a diagram illustrating an example of a partial configuration of a multiply-accumulate calculation device according to a first embodiment.

FIG. 2 is a diagram illustrating an example of a multiply calculation unit according to the first embodiment.

FIG. 3 is a diagram illustrating an example of a variable resistive element according to the first embodiment.

FIG. 4 is a diagram for describing an example of neural network calculation executed by a multiply-accumulate calculation device according to the first embodiment.

FIG. 5 is a diagram illustrating an example of a multiply calculation unit according to a second embodiment.

FIG. 6 is a diagram illustrating an example of a multiply calculation unit according to a third embodiment.

### DESCRIPTION OF EMBODIMENTS

### First Embodiment

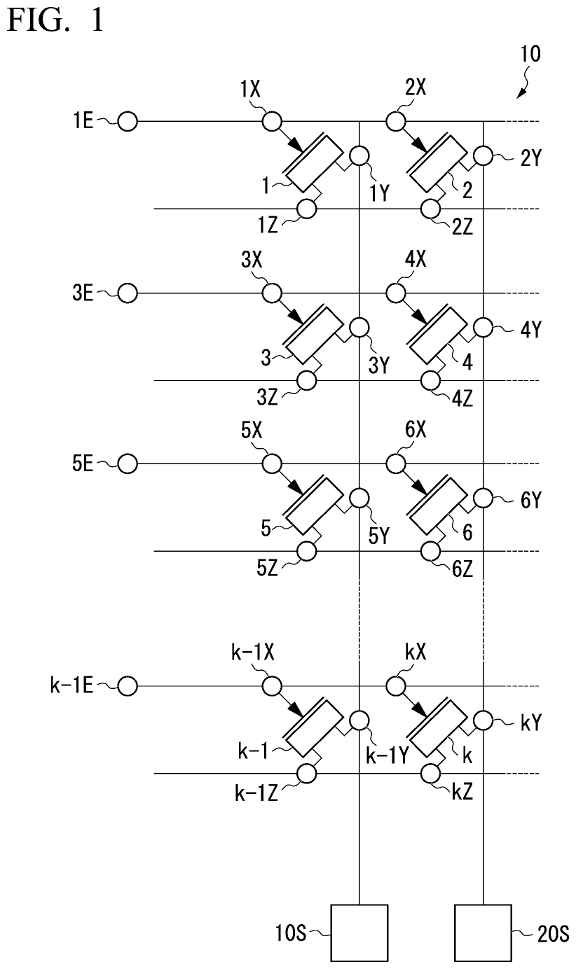

An example of a configuration of a multiply-accumulate calculation device according to a first embodiment will be described with reference to FIGS. 1 to 3. FIG. 1 is a diagram illustrating an example of a partial configuration of the multiply-accumulate calculation device according to the first embodiment.

As illustrated in FIG. 1, a multiply-accumulate calculation device 10 includes input units 1E, 3E, 5E, . . . , k-1E (k: even number), multiply calculation units 1, 2, 3, 4, 5, 6, . . . , k-1, and k (k: even number), read terminals 1X, 2X, 3X, 4X, 5X, 6X, . . . , k-1X, and kX (k: even number), common terminals 1Y, 2Y, 3Y, 4Y, 5Y, 6Y, . . . , k-1Y, and kY (k: even number), write terminals 1Z, 2Z, 3Z, 4Z, 5Z, 6Z, . . . , k-1Z, and kZ (k: even number), and accumulate calculation circuits 10S and 20S.

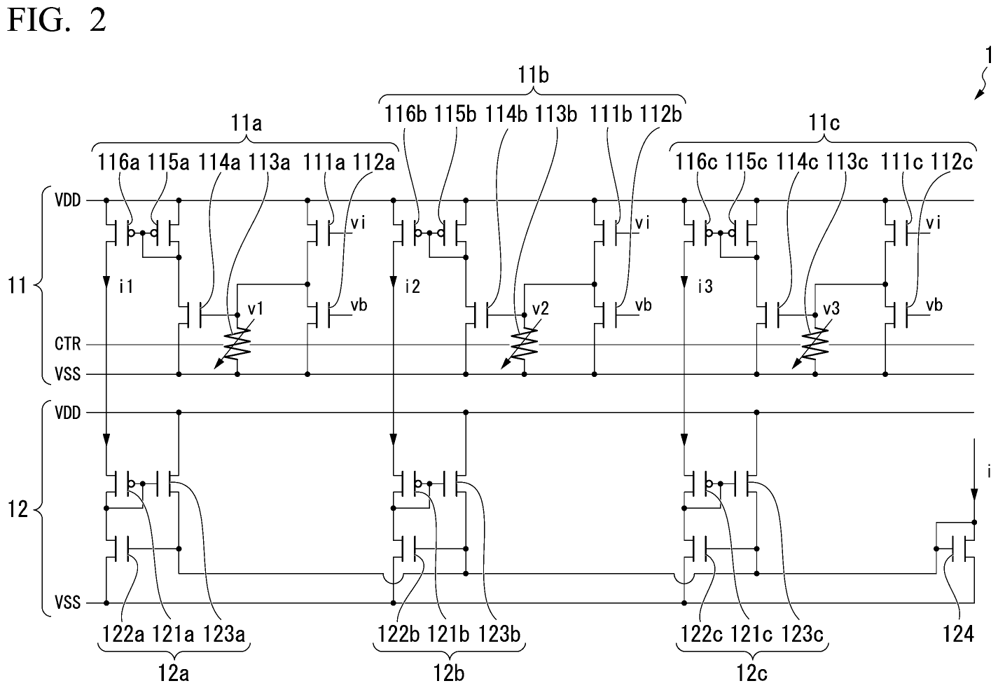

The read terminal 1X is a component of the multiply calculation unit 1, and is connected to a gate of an N-type MOSFET 111a, a gate of an N-type MOSFET 111b, and a gate of an N-type MOSFET 111c, which will be described below with reference to FIG. 2. Likewise, the read terminals 2X, 3X, 4X, 5X, 6X, . . . , k-1X, and kX are connected to gates of N-type MOSFETs that are components of the multiply calculation units 2, 3, 4, 5, 6, . . . , k-1, and k.

The common terminal 1Y is a component of the multiply calculation unit 1 and is connected to the common terminal of the multiply calculation element 113a, the common terminal of the multiply calculation element 113b, and the common terminal of the multiply calculation element 113c, which will be described below with reference to FIG. 2. Likewise, the common terminals 2Y, 3Y, 4Y, 5Y, 6Y, . . . , k-1Y, and kY are connected to the common terminals of the multiply calculation elements that are the components of the multiply calculation unit 2, 3, 4, 5, 6, . . . , k-1, and k.

The write terminal 1Z is a component of the multiply calculation unit 1 and is connected to the write terminal of the multiply calculation element 113a, the write terminal of the multiply calculation element 113b, and the write terminal of the multiply calculation element 113c, which will be described below with reference to FIG. 2. Likewise, the write terminals 2Z, 3Z, 4Z, 5Z, 6Z, . . . , k-1Z, and kZ are connected to write terminals of the multiply calculation elements that are components of the multiply calculation unit 2, 3, 4, 5, 6, . . . , k-1, and k.

The input unit 1E is connected to the read terminals 1X and 2X. Likewise, the input unit 3E is connected to the read terminals 3X and 4X. Also, the input unit 5E is connected to the read terminals 5X and 6X. Also, the input unit k-1E is connected to the read terminals k-1X and kX.

The input unit 1E inputs an input signal corresponding to an input value to the read terminals 1X and 2X. Likewise, the input unit 3E inputs an input signal corresponding to an input value to the read terminals 3X and 4X. Also, the input unit 5E inputs an input signal corresponding to an input value to the read terminals 5X and 6X. Also, the input unit k-1E inputs an input signal corresponding to an input value to the read terminals k-1X and kX. All of the above input signals are voltage signals that have been subjected to pulse width modulation (PWM) according to the input values.

FIG. 2 is a diagram illustrating an example of the multiply calculation unit according to the first embodiment. As illustrated in FIG. 2, the multiply calculation unit 1 includes a redundancy circuit 11 and an output signal generation circuit 12. Also, the multiply calculation units 2, 3, 4, 5, 6, . . . , k-1, and k have configurations similar to that of the multiply calculation unit 1 and operate like the multiply calculation unit 1. Therefore, an example of the multiply calculation unit 1 will be described below with respect to the multiply calculation unit 1, 2, 3, 4, 5, 6, . . . , k-1, and k.

The redundancy circuit 11 includes a first intermediate signal generation circuit 11a, a first intermediate signal generation circuit 11b, and a first intermediate signal generation circuit 11c.

Here, the first intermediate signal generation circuit 11b and the first intermediate signal generation circuit 11c have configurations similar to that of the first intermediate signal generation circuit 11a and operate like the first intermediate signal generation circuit 11a. Therefore, in the following description, the first intermediate signal generation circuit 11a will be mainly described with respect to the redundancy circuit 11.

First, a configuration of the first intermediate signal generation circuit 11a will be described. As illustrated in FIG. 2, the first intermediate signal generation circuit 11a includes an N-type MOSFET 111a, an N-type MOSFET 112a, a multiply calculation element 113a, an N-type MOSFET 114a, a P-type MOSFET 115a, and a P-type MOSFET 116a.

The N-type MOSFET 111a includes a gate connected to the read terminal 1X, a drain connected to VDD, and a source connected to the drain of the N-type MOSFET 112a, the read terminal of the multiply calculation element 113a, and the gate of the N-type MOSFET 114a. The N-type MOSFET 112a includes a gate to which a predetermined bias voltage is input, a drain connected to the source of the N-type MOSFET 111a, a read terminal of the multiply calculation element 113a, and the gate of the N-type MOSFET 114a, and a source connected to VSS and the common terminal 1Y illustrated in FIG. 1. Also, the N-type MOSFET 111a and the N-type MOSFET 112a form a source follower.

The multiply calculation element 113a includes a read terminal connected to the source of the N-type MOSFET 111a and the drain of the N-type MOSFET 112a, a common terminal connected to VSS and the common terminal 1Y illustrated in FIG. 1, and a write terminal connected to CRT, i.e., the write terminal 1Z illustrated in FIG. 1.

The N-type MOSFET 114a includes a gate connected to the source of the N-type MOSFET 111a, the drain of the N-type MOSFET 112a, and the read terminal of the multiply calculation element 113a, a drain connected to the drain of the P-type MOSFET 115a, and a source connected to VSS and the common terminal 1Y illustrated in FIG. 1.

The P-type MOSFET 115a includes a gate connected to the drain of the N-type MOSFET 114a, a drain of the P-type MOSFET 115a, and a gate of the P-type MOSFET 116a, and the drain connected to the drain of the N-type MOSFET 114a, the gate of the P-type MOSFET 115a, and a gate of the P-type MOSFET 116a, and a source connected to VDD. The P-type MOSFET 116a includes a gate connected to the drain of the N-type MOSFET 114a, the gate of the P-type MOSFET 115a, and the drain of the P-type MOSFET 115a, a drain connected to the source of the P-type MOSFET 121a to be described below, and a source connected to VDD. Also, the P-type MOSFET 115a and the P-type MOSFET 116a form a current mirror.

Next, an operation of the first intermediate signal generation circuit 11a will be described. When an input signal corresponding to the input value, for example, a voltage vi illustrated in FIG. 2, is input from the read terminal 1X, the first intermediate signal generation circuit 11a applies a voltage v1 based on a gate-source voltage of the N-type MOSFET 111a and a bias voltage of the N-type MOSFET 112a to the read terminal of the multiply calculation element 113a. The above voltage v1 is an example of a first intermediate signal. A current based on the above voltage flows between the read terminal and the common terminal of the multiply calculation element 113a and a voltage based on the above current and a magnitude of resistance of the multiply calculation element 113a is applied to the gate of the N-type MOSFET 114a.

A current i1 based on the voltage applied to the gate of the N-type MOSFET 114a flows between the drain and the source of the N-type MOSFET 114a. The above current i1 is an example of a second intermediate signal, which also flows between the drain and the source of the P-type MOSFET 115a constituting the current mirror, is transferred as a current flowing between the drain and the source of the P-type MOSFET 116a, and is output to the second intermediate signal generation circuit 12a.

Also, the first intermediate signal generation circuit 11b includes an N-type MOSFET 111b, an N-type MOSFET 112b, a multiply calculation element 113b, an N-type MOSFET 114b, a P-type MOSFET 115b, and a P-type MOSFET 116b. Also, the first intermediate signal generation circuit 11c includes an N-type MOSFET 111c, an N-type MOSFET 112c, a multiply calculation element 113c, an N-type MOSFET 114c, a P-type MOSFET 115c, and a P-type MOSFET 116c. Configurations and operations of the first intermediate signal generation circuit 11b and the first intermediate signal generation circuit 11c are similar to those of the first intermediate signal generation circuit 11a. That is, the first intermediate signal generation circuit 11b outputs the first intermediate signal, for example, a current i2 illustrated in FIG. 2, to the second intermediate signal generation circuit 12b according to a configuration and an operation similar to those of the first intermediate signal generation circuit 11a. Also, the first intermediate signal generation circuit 11c outputs the first intermediate signal, for example, a current i3 illustrated in FIG. 2, to the second intermediate signal generation circuit 12c according to a configuration and an operation similar to those of the first intermediate signal generation circuit 11a.

As described above, the redundancy circuit 11 includes the multiply calculation element 113a, the multiply calculation element 113b, and the multiply calculation element 113c. The redundancy circuit 11 inputs the voltage v1, a voltage v2, and a voltage v3 that are first intermediate signals generated from the voltage vi, which is the input signal corresponding to the input value, into the multiply calculation element 113a, the multiply calculation element 113b, and the multiply calculation element 113c. The redundancy circuit 11 generates and outputs the current i1, the current i2, and the current i3 that are second intermediate signals, each of which corresponds to a signal obtained by multiplying each of the voltage v1, the voltage v2, and the voltage v3, which are the first intermediate signals, by a weight in the multiply calculation element 113a, the multiply calculation element 113b, and the multiply calculation element 113c.

The output signal generation circuit 12 includes a second intermediate signal generation circuit 12a, a second intermediate signal generation circuit 12b, a second intermediate signal generation circuit 12c, and a current output circuit 124.

Here, the second intermediate signal generation circuit 12b and the second intermediate signal generation circuit 12c have configurations similar to that of the second intermediate signal generation circuit 12a and operate like the second intermediate signal generation circuit 12a. Therefore, in the following description, the second intermediate signal generation circuit 12a will be mainly described with respect to the output signal generation circuit 12.

First, the configuration of the second intermediate signal generation circuit 12a will be described. As illustrated in FIG. 2, the second intermediate signal generation circuit 12a includes the P-type MOSFET 121a, an N-type MOSFET 122a, and an N-type MOSFET 123a.

The P-type MOSFET 121a includes a gate connected to a drain of the P-type MOSFET 121a, a drain of the N-type MOSFET 122a, and a gate of the N-type MOSFET 123a and connected to a gate of the N-type MOSFET 123a, the drain connected to a gate of the P-type MOSFET 121a, the drain of the N-type MOSFET 122a, and the gate of the N-type MOSFET 123a, and the source connected to the drain of the P-type MOSFET 116a.

The N-type MOSFET 122a includes a gate connected to the source of the N-type MOSFET 123a and the gate of the N-type MOSFET constituting the current output circuit 124, the drain connected to the gate of the P-type MOSFET 121a, the drain of the P-type MOSFET 121a, and the gate of the N-type MOSFET 123a, and a source connected to VSS.

The N-type MOSFET 123a includes the gate connected to the gate of the P-type MOSFET 121a, the drain of the P-type MOSFET 121a and the drain of the N-type MOSFET 122a, a drain connected to VDD, and a source connected to the gate of the N-type MOSFET 122a and the gate of the N-type MOSFET constituting the current output circuit 124.

Next, the operation of the second intermediate signal generation circuit 12a will be described. The current i1 output from the first intermediate signal generation circuit 11a is input to the second intermediate signal generation circuit 12a. The current i1 flows between the source and the drain of the P-type MOSFET 121a and between the drain and the source of the N-type MOSFET 122a. Thereby, a current based on the current i1 flows between the drain and the source of the N-type MOSFET 123a and a voltage based on the above current and the internal resistance of the N-type MOSFET 123a is applied to the gate of the N-type MOSFET 122a and the source of the N-type MOSFET 123a.

Also, the second intermediate signal generation circuit 12b includes a P-type MOSFET 121b, an N-type MOSFET 122b, and an N-type MOSFET 123b. Also, the second intermediate signal generation circuit 12c includes a P-type MOSFET 121c, an N-type MOSFET 122c, and an N-type MOSFET 123c. Configurations and operations of the second intermediate signal generation circuit 12b and the second intermediate signal generation circuit 12c are similar to those of the second intermediate signal generation circuit 12a.

As illustrated in FIG. 2, the current output circuit 124 includes an N-type MOSFET. The above N-type MOSFET includes a gate connected to the gate of the N-type MOSFET 122a, the gate of the N-type MOSFET 122b, and the gate of the N-type MOSFET 122c and a source connected to VSS. A voltage determined on the basis of a voltage applied to the gate of the N-type MOSFET 122a, a voltage applied to the gate of the N-type MOSFET 122b, and a voltage applied to the gate of the N-type MOSFET 122c is applied to the gate of the above N-type MOSFET. Thereby, the current i illustrated in FIG. 2 flows between the drain and the source of the above N-type MOSFET. The above current i is an example of an output signal, and is, for example, transferred by a current mirror and output from the multiply calculation unit 1 by the common terminal 1Y.

As described above, the output signal generation circuit 12 generates and outputs a current i that is an output signal on the basis of the current i1, the current i2, and the current i3 that are the second intermediate signals.

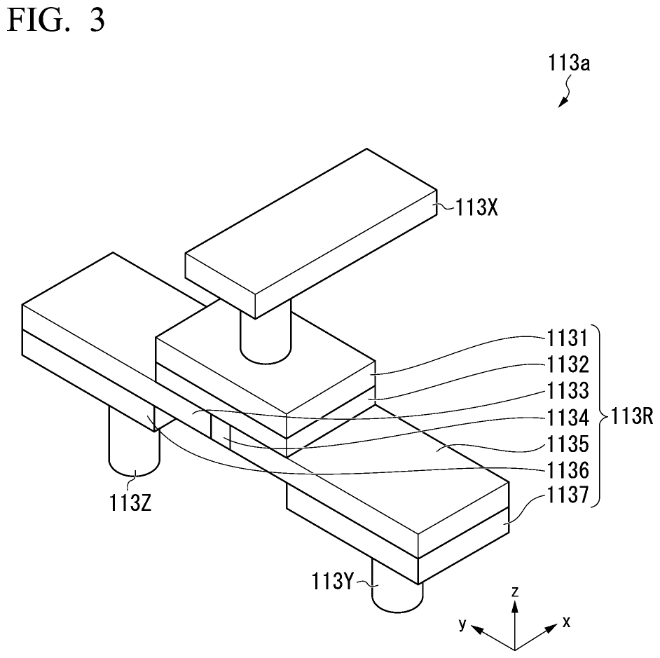

Next, an example of the multiply calculation element according to the first embodiment will be described with reference to FIG. 3. FIG. 3 is a diagram illustrating an example of the variable resistive element according to the first embodiment. Each of the multiply calculation element 113a, the multiply calculation element 113b, and the multiply calculation element 113c described above is, for example, the variable resistive element illustrated in FIG. 3. In the following description, the multiply calculation element 113a will be described as an example. Also, in the description using FIG. 3, an x-axis, a y-axis, and a z-axis illustrated in FIG. 3 are used. The x-axis, the y-axis, and the z-axis form three-dimensional Cartesian coordinates of a right-handed system.

As illustrated in FIG. 3, the multiply calculation element 113a is, for example, the variable resistive element including a variable resistor 113R, a read terminal 113X, a common terminal 113Y, and a write terminal 113Z.

The variable resistor 113R includes, for example, a magnetization fixed layer 1131, a nonmagnetic layer 1132, a first region 1133, a magnetic domain wall 1134, a second region 1135, a first magnetization supply layer 1136, and a second magnetization supply layer 1137. The magnetization fixed layer 1131, the nonmagnetic layer 1132, the first region 1133, the second region 1135, the first magnetization supply layer 1136, and the second magnetization supply layer 1137 are formed in a thin rectangular shape laminated in a z-axis direction and are electrically and magnetically connected to the first region 1133 and the second region 1135 in which a plane having a largest area is parallel to an xy plane. Although the magnetization fixed layer 1131, the nonmagnetic layer 1132, the first region 1133, the second region 1135, the first magnetization supply layer 1136, and the second magnetization supply layer 1137 are laminated in that order, a lamination direction may be a reverse direction. In this case, positions of the read terminal 113X, the common terminal 113Y, and the write terminal 113Z are also reversed.

The magnetization direction of the magnetization fixed layer 1131 is fixed in a z direction. Here, the fact that the magnetization is fixed means that the magnetization direction does not change at the time of initialization for introducing the magnetic domain wall 1134 and between before and after writing using the write current. Also, the magnetization fixed layer 1131 may be, for example, a perpendicular magnetization film having in-plane magnetic anisotropy or perpendicular magnetic anisotropy.

One surface of the nonmagnetic layer 1132 is in contact with a surface opposite to the surface on which the magnetization fixed layer 1131 in the z direction is in contact with the read terminal 113X. The other surface in the z direction is in contact with the first region 1133 and the second region 1135. Although the surface of the magnetization fixed layer 1131 facing in the z direction and the surface of the nonmagnetic layer 1132 facing in the z direction may have the same shape and area as each other, the nonmagnetic layer 1132 may be extended to cover the first region 1133 and the second region 1135 on the xy plane and may be larger than the magnetization fixed layer 1131. Also, the nonmagnetic layer 1132 is used in the multiply calculation element 113a to read a change in a magnetization state of a magnetization free layer with respect to the magnetization fixed layer 1131 as a change in a resistance value.

The first region 1133, the magnetic domain wall 1134, and the second region 1135 form the magnetization free layer. The magnetization free layer is made of a ferromagnetic material and magnetization directions of the first region 1133 and the second region 1135 are opposite to each other in the z direction. The magnetic domain wall 1134 faces in a direction approximately intermediate between the first region 1133 and the second region 1135. For example, when the magnetization direction of the first region 1133 is fixed in a +z direction, the magnetization fixed layer 1131 and the nonmagnetic layer 1132 are in contact with each other on a surface opposite to the surface where they are in contact with each other in the z direction. On the other hand, when the magnetization direction of the second region 1135 is fixed in a −z direction, the magnetization fixed layer 1131 and the nonmagnetic layer 1132 are in contact with each other on a surface opposite to the surface where they are in contact with each other in the z direction. The magnetic domain wall 1134 is sandwiched between the first region 1133 and the second region 1135 in the y direction.

Preferably, the first magnetization supply layer 1136 does not overlap the magnetization fixed layer 1131 in the z direction, and the surface of the first magnetization supply layer 1136 facing in the +z direction is in contact with the surface of the first region 1133 facing in the −z direction. Also, the first magnetization supply layer 1136 has a function of fixing the magnetization direction to a desired direction in a range of the first region 1133 overlapping the first magnetization supply layer 1136 in the z direction. Further, the write terminal 113Z is connected to the surface of the first magnetization supply layer 1136 facing in the −z direction. Also, the first magnetization supply layer 1136 is fabricated by, for example, a material that is the same as the ferromagnetic material capable of being used for the magnetization fixed layer 1131, an antiferromagnet such as IrMn, and a synthetic antiferromagnetic structure including a ferromagnetic material/nonmagnetic material/ferromagnetic material in which a nonmagnetic intermediate layer such as Ru or Ir is sandwiched.

Preferably, the second magnetization supply layer 1137 does not overlap the magnetization fixed layer 1131 in the z direction, and the surface of the second magnetization supply layer 1137 facing in the +z direction is in contact with the surface of the second region 1135 facing in the −z direction. Also, the second magnetization supply layer 1137 has a function of fixing the magnetization direction to a desired direction in a range of the second region 1135 overlapping the second magnetization supply layer 1137 in the z direction. Further, the common terminal 113Y is connected to the surface of the second magnetization supply layer 1137 facing in the −z direction. Also, the second magnetization supply layer 1137 is fabricated by, for example, a material that is the same as the ferromagnetic material capable of being used for the magnetization fixed layer 1131, an antiferromagnet such as IrMn, and a synthetic antiferromagnetic structure including a ferromagnetic material/nonmagnetic material/ferromagnetic material in which a nonmagnetic intermediate layer such as Ru or Ir is sandwiched.

The magnetization direction of the magnetization fixed layer 1131 and the magnetization directions of the first region 1133, the second region 1135, the first magnetization supply layer 1136, and the second magnetization supply layer 1137 in the variable resistor 113R may be the x direction and the y direction as well as the z direction. In this case, it is preferable that the magnetization direction of the magnetization fixed layer 1131 be the same as the magnetization direction of the first region 1133, the second region 1135, the first magnetization supply layer 1136, and the second magnetization supply layer 1137. For example, when the magnetization direction of the magnetization fixed layer 1131 is a +y direction, the magnetization direction of the first region is the +y direction, the magnetization direction of the second region is a −y direction, the magnetization direction of the first magnetization supply layer 1136 is the +y direction, and the magnetization direction of the second magnetization supply layer 1137 is the −y direction.

The multiply calculation element 113a causes the position of the magnetic domain wall 1134 in the y direction to be changed by adjusting a magnitude and a time period of the write current flowing between the common terminal 113Y and the write terminal 113Z. Thereby, the multiply calculation element 113a can cause an area ratio between a region where magnetization directions are parallel and a region where magnetization directions are antiparallel to be continuously changed and can cause a resistance value of the variable resistor 113R to be changed substantially linearly. Here, the region where the magnetization directions are parallel has an area of a part of the first region 1133 overlapping the magnetization fixed layer 1131 in the z direction. Also, the region where the magnetization directions are antiparallel has an area of a part of the second region 1135 overlapping the magnetization fixed layer 1131 in the z direction. Also, the write current is input to the write terminal 113Z. A magnitude and a time period of the write current are adjusted by at least one of the number of current pulses and a current pulse width.

Also, the multiply calculation element 113a may be a tunnel magneto-resistive effect element. The tunnel magneto-resistive element includes a magnetization fixed layer, a magnetization free layer, and a tunnel barrier layer serving as a nonmagnetic layer. The magnetization fixed layer and the magnetization free layer are made of a ferromagnetic material and have magnetization. The tunnel barrier layer is sandwiched between the magnetization fixed layer and the magnetization free layer. The tunnel magneto-resistive element can change the resistance value by changing a relationship between the magnetization of the magnetization fixed layer and the magnetization of the magnetization free layer.

The accumulate calculation circuit 10S calculates a sum of the output signals output by the multiply calculation units 1, 3, 5, . . . , k-1. Likewise, the accumulate calculation circuit 20S calculates a sum of output signals output by the multiply calculation units 2, 4, 6, k.

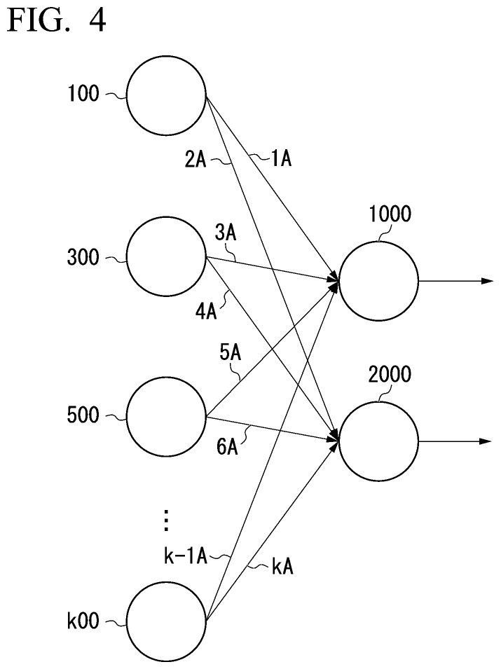

Next, an example of neural network calculation executed by the multiply-accumulate calculation device according to the first embodiment will be described with reference to FIG. 4. FIG. 4 is a diagram for describing an example of neural network calculation executed by the multiply-accumulate calculation device according to the first embodiment.

Nodes 100, 300, . . . , k00 form an input layer. Perceptrons 1000 and 2000 form a hidden layer or an output layer. The node 100 corresponds to the input unit 1E illustrated in FIG. 1 and outputs an input value corresponding to an input signal to the perceptrons 1000 and 2000. Likewise, the nodes 300, 500, . . . , k00 correspond to the input units 3E, 5E . . . , k-1E, respectively, and output input values corresponding to input signals to the perceptrons 1000 and 2000.

An arrow 1A corresponds to the multiply calculation unit 1 and indicates that the input value output by the node 100 is multiplied by the weight and the value corresponding to the output signal is input to the perceptron 1000. Likewise, an arrow 2A corresponds to the multiply calculation unit 2 and indicates that the input value output by the node 100 is multiplied by the weight and the value corresponding to the output signal is input to the perceptron 2000. The same is also true for arrows 3A, 4A, 5A, 6A k-1A, and kA.

The perceptron 1000 corresponds to the accumulate calculation circuit 10S illustrated in FIG. 1, calculates the sum of the values input from the arrows 1A, 3A, 5A k-1A, performs activation function processing on the above sum, and outputs a processing result. Likewise, the perceptron 2000 corresponds to the accumulate calculation circuit 20S illustrated in FIG. 1, calculates a sum of the values input from the arrows 2A, 4A, 6A kA, performs activation function processing on the above sum, and outputs a processing result.

The multiply-accumulate calculation device 10 according to the first embodiment has been described above. The multiply-accumulate calculation device 10 inputs the voltage v1, the voltage v2, and the voltage v3 that are the first intermediate signals generated from the voltage vi, which is the input signal corresponding to the input value, to the multiply calculation element 113a, the multiply calculation element 113b, and the multiply calculation element 113c. Next, the multiply-accumulate calculation device 10 generates and outputs the current i1, the current i2, and the current i3 that are the second intermediate signals corresponding to each of the signals obtained by multiplying the voltage v1, the voltage v2, and the voltage v3, which are the first intermediate signals, by the weight in the multiply calculation element 113a, the multiply calculation element 113b, and the multiply calculation element 113c. The multiply-accumulate calculation device 10 generates a current i, which is an output signal, on the basis of the current i1, the current i2, and the current i3, which are the second intermediate signals, and outputs the current i, which is the output signal.

Therefore, the multiply-accumulate calculation device 10 can output an appropriate output signal on the basis of a plurality of second intermediate signals even if a failure occurs in at least one of the multiply calculation elements included in the multiply calculation units 1, 2, 3, 4, 5, 6, . . . , k-1 or k and a first intermediate signal different from that of the normal time is output from the multiply calculation element in which the failure occurs. Thereby, the multiply-accumulate calculation device 10 can execute an accurate multiply-accumulate calculation even if a failure occurs in the multiply calculation element.

Also, the failure mentioned here is, for example, a short mode failure or an open mode failure. The short mode failure is a phenomenon in which a nonmagnetic layer of a multiply-accumulate calculation element, for example, the nonmagnetic layer of the multiply calculation element 113a, is destroyed leading to dielectric breakdown and an extremely large current flows between the read terminal and the common terminal. The open mode failure is a phenomenon in which a resistance value of a multiply-accumulate calculation element, for example, the multiply calculation element 113a, becomes extremely large, and the current flowing between the read terminal and the common terminal becomes extremely small.

Also, the multiply-accumulate calculation device 10 generates each of the voltage v1, the voltage v2, and the voltage v3 that are the first intermediate signals by the source follower. Therefore, the multiply-accumulate calculation device 10 can automatically generate the voltage v1, the voltage v2, and the voltage v3 that are the first intermediate signals only by inputting an input signal, without executing any particular control or the like.

Although a case in which the redundancy circuit 11 includes the first intermediate signal generation circuit 11a, the first intermediate signal generation circuit 11b, and the first intermediate signal generation circuit 11c and the output signal generation circuit 12 includes the second intermediate signal generation circuit 12a, the second intermediate signal generation circuit 12b, and the second intermediate signal generation circuit 12c has been described as an example in the first embodiment, the present invention is not limited thereto. For example, the redundancy circuit 11 may not include the first intermediate signal generation circuit 11a and the output signal generation circuit 12 may not include the second intermediate signal generation circuit 12a. Alternatively, the redundancy circuit 11 may further include at least one other first intermediate signal generation circuit and the output signal generation circuit 12 may further include at least one other second intermediate signal generation circuit.

### Second Embodiment

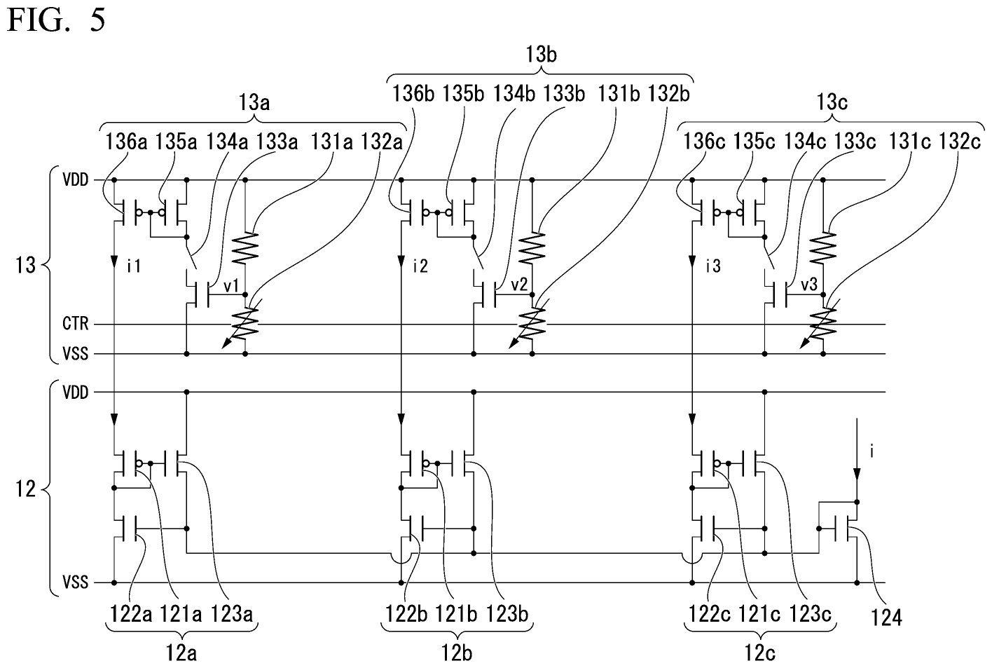

A multiply-accumulate calculation device according to a second embodiment will be described with reference to FIG. 5. FIG. 5 is a diagram illustrating an example of a multiply calculation unit according to the second embodiment. The multiply-accumulate calculation device according to the second embodiment is different from the multiply-accumulate calculation device 10 according to the first embodiment in that a redundancy circuit 13 illustrated in FIG. 5 is included instead of the redundancy circuit 11 described above.

Therefore, in the description of the second embodiment, only differences from the first embodiment will be described and duplicate description will be omitted.

The redundancy circuit 13 includes a first intermediate signal generation circuit 13a, a first intermediate signal generation circuit 13b, and a first intermediate signal generation circuit 13c.

Here, the first intermediate signal generation circuit 13b and the first intermediate signal generation circuit 13c have configurations similar to that of the first intermediate signal generation circuit 13a and operate like the first intermediate signal generation circuit 13a. Therefore, in the following description, the first intermediate signal generation circuit 13a will be mainly described with respect to the redundancy circuit 13.

First, a configuration of the first intermediate signal generation circuit 13a will be described. As illustrated in FIG. 5, the first intermediate signal generation circuit 13a includes a resistor 131a, a multiply calculation element 132a, an N-type MOSFET 133a, a switch 134a, a P-type MOSFET 135a, and a P-type MOSFET 136a.

The resistor 131a has one end connected to VDD and the other end connected to a read terminal of the multiply calculation element 132a and a gate of the N-type

MOSFET 133a. The multiply calculation element 132a includes the read terminal connected to the other end of the resistor 131a and the gate of the N-type MOSFET 133a, a common terminal connected to VSS and a common terminal 1Y illustrated in FIG. 1, and a write terminal connected to CTR, i.e., a write terminal 1Z illustrated in FIG. 1.

The N-type MOSFET 133a includes the gate connected to the other end of the resistor 131a and the read terminal of the multiply calculation element 132a, a drain connected to one end of the switch 134a, and a source connected to VSS. The switch 134a has the one end connected to the drain of the N-type MOSFET 133a, the other end connected to a drain of the P-type MOSFET 135a, a gate of the P-type MOSFET 135a, and a gate of the P-type MOSFET 136a.

The P-type MOSFET 135a includes the gate connected to the other end of the switch 134a, the drain of the P-type MOSFET 135a and the gate of the P-type MOSFET 136a, the drain connected to the other end of the switch 134a, the gate of the P-type MOSFET 135a, and the gate of the P-type MOSFET 136a, and a source connected to VDD. The P-type MOSFET 136a includes the gate connected to the other end of the switch 134a, the drain of the P-type MOSFET 135a and the gate of the P-type MOSFET 135a, a drain connected to a source of a P-type MOSFET 121a, and a source connected to VDD. Also, the P-type MOSFET 135a and the P-type MOSFET 136a form a current mirror.

Next, an operation of the first intermediate signal generation circuit 13a will be described. When a voltage vi, which is an input signal, is applied to a read terminal 1X, the first intermediate signal generation circuit 13a applies a voltage v1 based on a magnitude of resistance of the resistor 131a and a magnitude of resistance of the multiply calculation element 132a to the read terminal of the multiply calculation element 132a. The above voltage v1 is an example of a first intermediate signal. A current based on the above voltage flows between the read terminal and the common terminal of the multiply calculation element 132a and a voltage based on the above current, the magnitude of the resistance of the multiply calculation element 132a, and the magnitude of the resistance of the resistor 131a is applied to the gate of the N-type MOSFET 133a.

When the switch 134a is in a conductive state, a current i1 based on the voltage applied to the gate of the N-type MOSFET 133a flows between the drain and the source of the N-type MOSFET 133a. The above current i1 is an example of a second intermediate signal, which also flows between the drain and the source of the P-type MOSFET 135a constituting the current mirror, is transferred as a current flowing between the drain and the source of the P-type MOSFET 136a, and is output to the second intermediate signal generation circuit 12a. When the switch 134a is in a non-conductive state, no current flows between the source and drain of the P-type MOSFET 135a. Also, the switch 134a is in a conductive state when the multiply-accumulate calculation is executed and is in a non-conductive state when the multiply-accumulate calculation is not executed.

Also, the first intermediate signal generation circuit 13b includes a resistor 131b, a multiply calculation element 132b, an N-type MOSFET 133b, a switch 134b, a P-type MOSFET 135b, and a P-type MOSFET 136b. Also, the first intermediate signal generation circuit 13c includes a resistor 131c, a multiply calculation element 132c, an N-type MOSFET 133c, a switch 134c, a P-type MOSFET 135c, and a P-type MOSFET 136c. Configurations and operations of the first intermediate signal generation circuit 13b and the first intermediate signal generation circuit 13c are similar to those of the first intermediate signal generation circuit 13a. That is, the first intermediate signal generation circuit 13b outputs the first intermediate signal, for example, a current i2 illustrated in FIG. 5, to the second intermediate signal generation circuit 12b according to a configuration and an operation similar to those of the first intermediate signal generation circuit 13a. Also, the first intermediate signal generation circuit 13c outputs the first intermediate signal, for example, a current i3 illustrated in FIG. 5, to the second intermediate signal generation circuit 12c according to a configuration and an operation similar to those of the first intermediate signal generation circuit 13a.

The multiply-accumulate calculation device according to the second embodiment has been described above. The multiply-accumulate calculation device according to the second embodiment can have effects similar to those of the multiply-accumulate calculation device 10 according to the first embodiment.

Also, the multiply-accumulate calculation device according to the second embodiment includes the resistor 131a, the resistor 131b, and the resistor 131c connected in series to the multiply calculation element 132a, the multiply calculation element 132b, and the multiply calculation element 132c, respectively, instead of the source follower included in the multiply-accumulate calculation device 10 according to the first embodiment.

Therefore, because the multiply-accumulate calculation device according to the second embodiment has a simpler configuration than the multiply-accumulate calculation device 10 according to the first embodiment, it is possible to limit an increase in the circuit scale and limit the manufacturing cost.

### Third Embodiment

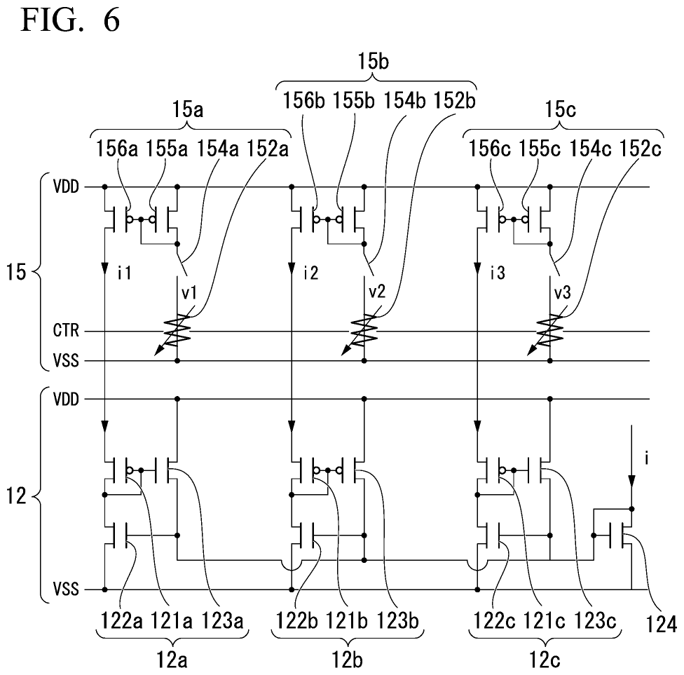

A multiply-accumulate calculation device according to a third embodiment will be described with reference to FIG. 6. FIG. 6 is a diagram illustrating an example of a multiply calculation unit according to the third embodiment. The multiply-accumulate calculation device according to the third embodiment is different from the multiply-accumulate calculation device 10 according to the first embodiment and the multiply-accumulate calculation device according to the second embodiment in that a redundancy circuit 15 illustrated in FIG. 6 is provided instead of the redundancy circuit 11 and the redundancy circuit 13 described above. Therefore, in the description of the third embodiment, only differences from the first embodiment and the second embodiment will be described, and duplicate description will be omitted.

The redundancy circuit 15 includes a first intermediate signal generation circuit 15a, a first intermediate signal generation circuit 15b, and a first intermediate signal generation circuit 15c.

Here, the first intermediate signal generation circuit 15b and the first intermediate signal generation circuit 15c have configurations similar to that of the first intermediate signal generation circuit 15a, and operate like the first intermediate signal generation circuit 15a. Therefore, in the following description, the first intermediate signal generation circuit 15a will be mainly described with respect to the redundancy circuit 15.

First, the configuration of the first intermediate signal generation circuit 15a will be described. As illustrated in FIG. 5, the first intermediate signal generation circuit 15a includes a multiply calculation element 152a, a switch 154a, a P-type MOSFET 155a, and a P-type MOSFET 156a.

The multiply calculation element 152a includes a read terminal connected to one end of the switch 154a, a common terminal connected to VSS and a common terminal 1Y illustrated in FIG. 1, and a write terminal connected to CTR, i.e., a write terminal 1Z illustrated in FIG. 1.

The switch 154a has the one end connected to the read terminal of the multiply calculation element 152a, and the other end connected to a drain of the P-type MOSFET 155a, a gate of the P-type MOSFET 155a, and a gate of the P-type MOSFET 156a.

The P-type MOSFET 155a includes the gate connected to the other end of the switch 154a, a drain of the P-type MOSFET 155a and the gate of the P-type MOSFET 156a, the drain connected to the other end of the switch 154a, the gate of the P-type MOSFET 155a and the gate of the P-type MOSFET 156a, and a source connected to VDD. The P-type MOSFET 156a includes the gate connected to the other end of the switch 154a, the drain of the P-type MOSFET 155a, and the gate of the P-type MOSFET 155a, a drain connected to a source of a P-type MOSFET 121a, and a source connected to VDD. Also, the P-type MOSFET 155a and the P-type MOSFET 156a form a current mirror.

Next, an operation of the first intermediate signal generation circuit 15a will be described. When a voltage vi, which is an input signal, is applied to a read terminal 1X, the first intermediate signal generation circuit 15a applies a voltage v1 based on a magnitude of resistance of the current mirror formed by the P-type MOSFET 155a and the P-type MOSFET 156a and a magnitude of resistance of the multiply calculation element 152a to the read terminal of the multiply calculation element 152a. The above voltage v1 is an example of the first intermediate signal. A current based on the above voltage flows between the read terminal and the common terminal of the multiply calculation element 152a and a voltage based on the above current, the magnitude of the resistance of the current mirror, the magnitude of the resistance of the multiply calculation element 152a is applied to the gate of the N-type MOSFET 153a.

When the switch 154a is in a conductive state, a current i1 based on the voltage v1 and the magnitude of the resistance of the multiply calculation element 152a flows between the read terminal and the common terminal of the multiply calculation element 152a. The above current i1 is an example of a second intermediate signal, which also flows between the drain and the source of the P-type MOSFET 155a constituting the current mirror, is transferred as a current flowing between the drain and the source of the P-type MOSFET 156a, and is output to the second intermediate signal generation circuit 12a. When the switch 154a is in a non-conductive state, no current flows between the source and the drain of the P-type MOSFET 155a. Also, the switch 154a is in a conductive state when the multiply-accumulate calculation is executed and is in a non-conductive state when no multiply-accumulate calculation is executed.

Also, the first intermediate signal generation circuit 15b includes a multiply calculation element 152b, a switch 154b, a P-type MOSFET 155b, and a P-type MOSFET 156b. Also, the first intermediate signal generation circuit 15c includes a multiply calculation element 152c, a switch 154c, a P-type MOSFET 155c, and a P-type MOSFET 156c. Configurations and operations of the first intermediate signal generation circuit 15b and the first intermediate signal generation circuit 15c are similar to those of the first intermediate signal generation circuit 15a. That is, the first intermediate signal generation circuit 15b outputs a first intermediate signal, for example, a current i2 illustrated in FIG. 6, to the second intermediate signal generation circuit 12b according to a configuration and an operation similar to those of the first intermediate signal generation circuit 15a. Also, the first intermediate signal generation circuit 15c outputs a first intermediate signal, for example, a current i3 illustrated in FIG. 6, to the second intermediate signal generation circuit 12c according to a configuration and an operation similar to those of the first intermediate signal generation circuit 15a.

The multiply-accumulate calculation device according to the third embodiment has been described above. The multiply-accumulate calculation device according to the third embodiment can have effects similar to those of the multiply-accumulate calculation device 10 according to the first embodiment and the multiply-accumulate calculation device according to the second embodiment.

Also, the multiply-accumulate calculation device according to the third embodiment does not have the source follower provided in the multiply-accumulate calculation device 10 according to the first embodiment. Further, the multiply-accumulate calculation device according to the third embodiment does not include the resistor 131a, the resistor 131b, the resistor 131c, the N-type MOSFET 133a, the N-type MOSFET 133b, and the N-type MOSFET 133c according to the second embodiment. On the other hand, the multiply-accumulate calculation device according to the third embodiment generates a voltage v1, a voltage v2, and a voltage v3 that are first intermediate signals using the internal resistance of each of the current mirrors connected in series to the multiply calculation element 152a, the multiply calculation element 152b, and the multiply calculation element 152c.

Therefore, because the multiply-accumulate calculation device according to the third embodiment has a simpler configuration than the multiply-accumulate calculation device 10 according to the first embodiment and the multiply-accumulate calculation device according to the second embodiment, it is possible to limit an increase in the circuit scale and limit the manufacturing cost.

Although a case in which the output signal generation circuit 12 generates the current i that is an output signal on the basis of the current i1, the current i2, and the current i3, which are the second intermediate signals, has been described as an example in the above-described three embodiments, the present invention is not limited thereto.

For example, the output signal generation circuit 12 may be a minimum value selection circuit in which a signal corresponding to a minimum value among the current i1, the current i2, and the current i3 that are the second intermediate signals is used as the output signal. Alternatively, the output signal generation circuit 12 may be a majority circuit in which a signal corresponding to a most frequent value among the current i1, the current i2, and the current i3 that are the second intermediate signals is used as the output signal.

Although a case in which the voltage v1, the voltage v2, and the voltage v3, which are the first intermediate signals, are generated by the redundancy circuit 11, the redundancy circuit 13, or the redundancy circuit 15 has been described as an example in the above-described three embodiments, the present invention is not limited thereto. For example, the voltage v1, the voltage v2, and the voltage v3, which are externally generated first intermediate signals, may be applied to the redundancy circuit 11, the redundancy circuit 13, and the redundancy circuit 15.

Also, the above-described multiply-accumulate calculation device 10 may be included in a logical calculation device or a neuromorphic device. The logical calculation device mentioned here is a logic circuit formed by combining a plurality of multiply-accumulate calculation devices 10, for example, an AND circuit and an OR circuit. Moreover, the logical calculation mentioned here is a concept including deep learning. The neuromorphic device mentioned here is a device that applies a structure of the brain and a mechanism by which nerve cells called neurons are fired, and is used for machine learning and the like.

Also, a process may be performed by recording a program for implementing a function of each device such as the multiply-accumulate calculation device 10 according to the first embodiment described above on a computer-readable recording medium and causing a computer system to read and execute the program recorded on the recording medium.

For example, the computer system mentioned here may include hardware such as an operating system (OS) and peripheral devices. Also, the computer-readable recording medium is, for example, a portable medium or a storage device. The portable medium is, for example, a floppy disk, a magneto-optical disk, a read only memory (ROM), a writable non-volatile memory such as a flash memory, or a digital versatile disc (DVD). The storage device is, for example, a hard disk built in a computer system. Also, the computer-readable recording medium may be a volatile memory inside the computer system including a server and a client when the program is transmitted via a network or a communication circuit.

Also, the above-described program may be transmitted from a computer system storing the program in a storage device or the like to another computer system via a transmission medium or by transmission waves in a transmission medium. Here, the transmission medium for transmitting the program refers to a medium having a function of transmitting information as in a network such as the Internet or a communication circuit such as a telephone circuit.

Also, the above-described program may be a program for implementing some of the above-described functions or a program capable of implementing the above-described function in combination with a program already recorded on the computer system, i.e., a so-called differential file (differential program). For example, the above-described program is read and executed by a processor such as a central processing unit (CPU) provided in the computer.

Although the first embodiment, the second embodiment, and the third embodiment of the present invention have been described in detail with reference to the drawings, the present invention is not limited to the three embodiments and various modifications and replacements can be applied without departing from the spirit and scope of the present invention. The configurations described in the above-described embodiments may be combined.

### REFERENCE SIGNS LIST

1 Multiply-accumulate calculation device
11, 13, 15 Redundancy circuit
12 Output signal generation circuit
10S, 20S Accumulate calculation circuit

1. A multiply-accumulate calculation device comprising:
a plurality of redundancy circuits including a plurality of multiply calculation elements and configured to input a plurality of first intermediate signals generated from an input signal corresponding to an input value to the plurality of multiply calculation elements and generate and output a plurality of second intermediate signals, each of which corresponds to a signal obtained by multiplying each of the plurality of first intermediate signals by a weight in each of the plurality of multiply calculation elements;
a plurality of output signal generation circuits configured to generate output signals on the basis of the plurality of second intermediate signals and output the output signals; and
an accumulate calculation circuit configured to calculate a sum of the output signals output by the plurality of output signal generation circuits.

2. The multiply-accumulate calculation device according to claim 1, wherein each of the plurality of multiply calculation elements is a variable resistive element having a write terminal, a common terminal, and a read terminal.

3. The multiply-accumulate calculation device according to claim 1, wherein each of the plurality of first intermediate signals is generated using a source follower.

4. The multiply-accumulate calculation device according to claim 1, wherein each of the plurality of first intermediate signals is generated using one of a plurality of resistors connected in series to each of the plurality of multiply calculation elements.

5. The multiply-accumulate calculation device according to claim 1, wherein each of the plurality of first intermediate signals is generated using internal resistance of one of a plurality of current mirrors connected in series to each of the plurality of multiply calculation elements.

6. The multiply-accumulate calculation device according to claim 1, wherein the output signal generation circuit is a minimum value selection circuit in which a signal corresponding to a minimum value among the plurality of second intermediate signals is used as the output signal.

7. The multiply-accumulate calculation device according to claim 1, wherein the output signal generation circuit is a majority circuit in which a signal corresponding to a most frequent value among the plurality of second intermediate signals is used as the output signal.

8. A logical calculation device comprising:
the multiply-accumulate calculation device according to claim 1.

9. A neuromorphic device comprising:
the multiply-accumulate calculation device according to claim 1.

10. A multiply-accumulate calculation method using the multiply-accumulate calculation device according to claim 1, the multiply-accumulate calculation method comprising:
a second intermediate signal generation step of inputting the plurality of first intermediate signals generated from the input signal corresponding to the input value to each of the plurality of multiply calculation elements and generating and outputting the plurality of second intermediate signals corresponding to each of the signals obtained by multiplying each of the plurality of first intermediate signals by the weight in each of the plurality of multiply calculation elements;
a plurality of output signal generation steps of generating the output signals on the basis of the plurality of second intermediate signals and outputting the output signals; and
an accumulate calculation step of calculating the sum of the output signals output by the plurality of output signal generation circuits.

11. The multiply-accumulate calculation device according to claim 2, wherein each of the plurality of first intermediate signals is generated using a source follower.

12. The multiply-accumulate calculation device according to claim 2, wherein each of the plurality of first intermediate signals is generated using one of a plurality of resistors connected in series to each of the plurality of multiply calculation elements.

13. The multiply-accumulate calculation device according to claim 2, wherein each of the plurality of first intermediate signals is generated using internal resistance of one of a plurality of current mirrors connected in series to each of the plurality of multiply calculation elements.

14. The multiply-accumulate calculation device according to claim 2, wherein the output signal generation circuit is a minimum value selection circuit in which a signal corresponding to a minimum value among the plurality of second intermediate signals is used as the output signal.

15. The multiply-accumulate calculation device according to claim 3, wherein the output signal generation circuit is a minimum value selection circuit in which a signal corresponding to a minimum value among the plurality of second intermediate signals is used as the output signal.

16. The multiply-accumulate calculation device according to claim 4, wherein the output signal generation circuit is a minimum value selection circuit in which a signal corresponding to a minimum value among the plurality of second intermediate signals is used as the output signal.

17. The multiply-accumulate calculation device according to claim 5, wherein the output signal generation circuit is a minimum value selection circuit in which a signal corresponding to a minimum value among the plurality of second intermediate signals is used as the output signal.

18. The multiply-accumulate calculation device according to claim 11, wherein the output signal generation circuit is a minimum value selection circuit in which a signal corresponding to a minimum value among the plurality of second intermediate signals is used as the output signal.

19. The multiply-accumulate calculation device according to claim 12, wherein the output signal generation circuit is a minimum value selection circuit in which a signal corresponding to a minimum value among the plurality of second intermediate signals is used as the output signal.

20. The multiply-accumulate calculation device according to claim 13, wherein the output signal generation circuit is a minimum value selection circuit in which a signal corresponding to a minimum value among the plurality of second intermediate signals is used as the output signal.
